(19) United States
(12) Patent Application Publication
(10) Pub. No.: US 2026/0251889 A1
(43) Pub. Date: Aug. 27, 2026

(54) FIXED-FOCUS PROJECTION OPTICAL SYSTEM

(71) Applicant: ZHONGSHAN UNITED OPTOELECTRONIC DISPLAY TECHNOLOGY CO., LTD., Zhongshan (CN)

(72) Inventors: Liwei QUAN, Zhongshan (CN); Junqiang GONG, Zhongshan (CN); Qinhe RAO, Zhongshan (CN); Shoulin LI, Zhongshan (CN)

(73) Assignee: ZHONGSHAN UNITED OPTOELECTRONIC DISPLAY TECHNOLOGY CO., LTD., Zhongshan (CN)

(21) Appl. No.: 19/079,934

(22) Filed: Mar. 14, 2025

(30) Foreign Application Priority Data
Feb. 24, 2025 (CN) 202510204030.2

(51) Int. Cl. G02B 13/16; G02B 9/64; G02B 26/08; G02B 26/10

(52) U.S. Cl. CPC G02B 13/16; G02B 9/64; G02B 26/0816; G02B 26/10

(57) ABSTRACT

Disclosed are a fixed-focus projection optical system and a projection device. The fixed-focus projection optical system is provided with an object side and an image side arranged relatively along an optical axis direction, and includes: a micro-mirror array, an equivalent prism, a galvanometer, a first lens group, a second lens group, a plane mirror, and a curved mirror provided in sequence from the object side to the image side. The plane mirror is provided at one side of the optical axis, and the curved mirror is provided at the other side of the optical axis. The plane mirror is provided at an angle with the optical axis, and one end of the plane mirror is intersected with the optical axis.

### CROSS-REFERENCE TO RELATED APPLICATIONS

The present application claims priority to Chinese Patent Application No. 202510204030.2, filed on Feb. 24, 2025, the entire contents of which are incorporated herein by reference.

### TECHNICAL FIELD

The present application relates to the field of optics, and in particular to a fixed-focus projection optical system.

### BACKGROUND

In recent years, with the development of projection, the ultra-short-focus projection has been widely used in the home, which can project a large screen at a short distance, and has a tendency to gradually replace the traditional television.

The ultra-short-focus projection lens design currently on the market mainly includes a refractive lens group and a single reflector group, and the length is often relatively large.

### SUMMARY

The main purpose of the present application is to provide a fixed-focus projection optical system and a projection device, aiming to provide a fixed-focus projection optical system with a small volume.

To achieve the above purpose, the present application provides a fixed-focus projection optical system. The fixed-focus projection optical system is provided with an object side and an image side arranged relatively along an optical axis direction, and includes: a micro-mirror array, an equivalent prism, a galvanometer, a first lens group, a second lens group, a plane mirror, and a curved mirror provided in sequence from the object side to the image side;
the plane mirror is provided at one side of the optical axis, and the curved mirror is provided at the other side of the optical axis;
the plane mirror is provided at an angle with the optical axis, and one end of the plane mirror is intersected with the optical axis;
an optical power of the first lens group is positive, and an optical power of the second lens group is negative; and
the second lens group is configured to move along the optical axis to focus the fixed-focus projection optical system in response to that a projection distance is changed.

In an embodiment, the first lens group includes a first lens, a second lens, a third lens, a fourth lens, a fifth lens, a sixth lens, a seventh lens, an aperture stop, and an eighth lens provided in sequence from the object side to the image side;
an optical power of the first lens is positive, and an optical power of the second lens is positive; an optical power of the third lens is positive, and an optical power of the fourth lens is negative; an optical power of the fifth lens is positive, and an optical power of the sixth lens is negative; an optical power of the seventh lens is positive, and an optical power of the eighth lens is positive; and
the second lens group includes a ninth lens, a tenth lens, an eleventh lens, a twelfth lens, and a thirteenth lens provided in sequence from the object side to the image side; an optical power of the ninth lens is positive, and an optical power of the tenth lens is positive; an optical power of the eleventh lens is negative, and an optical power of the twelfth lens is negative; and an optical power of the thirteenth lens is negative.

In an embodiment, the optical power of the first lens group is φ100, and the optical power of the second lens group is φ200; and
the optical power of the curved mirror is φ400, and the optical powers satisfy:

0.04≤|φ100|≤0.06, 0.003≤|φ200|≤0.01, 0.04≤|φ400|≤0.08.

In an embodiment, the optical power of the first lens group is φ100, and the optical power of the second lens group is φ200; and
a ratio of the optical power of the first lens group to the optical power of the second lens group satisfies:

7≤|φ100/φ200|≤11.

In an embodiment, the optical power of the first lens is φ1, and the optical power of the second lens is φ2; a sum of the optical power of the third lens, the optical power of the fourth lens, and the optical power of the fifth lens is φ345; a sum of the optical power of the sixth lens and the optical power of the seventh lens is φ67, and an optical power of the eighth lens is φ8; an optical power of the ninth lens is φ9, and a sum of the optical power of the tenth lens and the optical power of the eleventh lens is φ1011; the optical power of the twelfth lens is φ12, and the optical power of the thirteenth lens is φ13; and
the optical powers of the lenses satisfy:

0.01≤|φ1|≤0.03, 0.04≤|φ2|≤0.07, 0.002≤|φ345|≤0.05, 0.01≤|67|≤0.04, 0.02≤|φ8|≤0.05, 0.01≤|φ9|≤0.04, 0.01≤|φ1011|≤0.04, 0.01≤|φ12|≤0.04, 0.02≤|φ13|≤0.06.

In an embodiment, the first lens group includes a first lens, a second lens, a third lens, a fourth lens, a fifth lens, a sixth lens, a seventh lens, an aperture stop, and an eighth lens provided in sequence from the object side to the image side, and the second lens group includes a ninth lens, a tenth lens, an eleventh lens, a twelfth lens, and a thirteenth lens provided in sequence from the object side to the image side; and
a distance between a center of the thirteenth lens and a center of the plane mirror is T1, and a distance between a center of the plane mirror and a center of the curved mirror is T2; and a distance between a center of the first lens and the center of the thirteenth lens is T13, satisfying: 0.5≤T13/(T1+T2)≤0.9.

In an embodiment, the first lens group includes a first lens, a second lens, a third lens, a fourth lens, a fifth lens, a sixth lens, a seventh lens, an aperture stop, and an eighth lens provided in sequence from the object side to the image side; and
a distance from the first lens to an intersection of the plane mirror and the optical axis along the optical axis direction is T00, and a distance from the micro-mirror array to the first lens is T11; and a ratio of T00 to T11 satisfies:

T00/T11≤4.5.

In an embodiment, the first lens group includes a first lens, a second lens, a third lens, a fourth lens, a fifth lens, a sixth lens, a seventh lens, an aperture stop, and an eighth lens provided in sequence from the object side to the image side;
the second lens group includes a ninth lens, a tenth lens, an eleventh lens, a twelfth lens, and a thirteenth lens provided in sequence from the object side to the image side; and
the second lens, the eighth lens, and the ninth lens are glass aspherical lenses, and the twelfth lens, the thirteenth lens, and the curved mirror are plastic aspherical lenses.

In an embodiment, the first lens group includes a first lens, a second lens, a third lens, a fourth lens, a fifth lens, a sixth lens, a seventh lens, an aperture stop, and an eighth lens provided in sequence from the object side to the image side, and the second lens group includes a ninth lens, a tenth lens, an eleventh lens, a twelfth lens, and a thirteenth lens provided in sequence from the object side to the image side; and
the third lens, the fourth lens, and the fifth lens are glued together; the sixth lens is glued to the seventh lens, and the tenth lens is glued to the eleventh lens.

In an embodiment, an angle between the plane mirror and an optical axis of a refractive lens group is 45°.

In the technical solution of the present application, the image beam is emitted from the micro-mirror array, passes through the protective glass, the equivalent prism, the galvanometer, the first lens group and the second lens group in sequence. When the beam reaches the plane mirror, it is reflected by the plane mirror to the curved mirror, and is then reflected to the projection screen through the curved mirror, thereby changing the direction of the light path and shortening the length in the projection direction. The first imaging is performed between the plane mirror and the curved mirror, and the plane mirror and the curved mirror reflect the first imaging to the projection screen to form the second imaging. When it is necessary to change the size of the projection screen or the projection ratio, the second lens group is moved along the optical axis to focus the fixed-focus projection optical system. Through the reasonable arrangement of the structures and positions of the first lens group with positive optical power, the second lens group with negative positive optical power, the plane mirror and the curved mirror, the plane mirror and the curved mirror reflect the beam twice, which greatly reduces the length in the projection direction, so that the fixed-focus projection optical system has a small volume.

### BRIEF DESCRIPTION OF THE DRAWINGS

In order to illustrate the technical solutions in the embodiments of the present application or in the related art more clearly, the following briefly introduces the accompanying drawings required for the description of the embodiments or the related art. Obviously, the drawings in the following description are only part of embodiments of the present application. For those skilled in the art, other drawings can also be obtained according to the structures shown in these drawings without any creative effort.

FIG. 1 is a schematic structural diagram of a fixed-focus projection optical system according to an embodiment of the present application.

FIG. 2 is an optical path diagram of the fixed-focus projection optical system in FIG. 1.

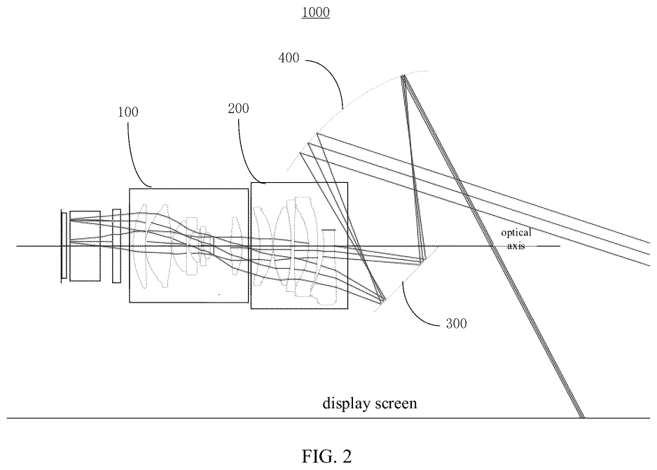

The realization of the objective, functional characteristics, and advantages of the present application are further described with reference to the accompanying drawings.

### DETAILED DESCRIPTION OF THE EMBODIMENTS

The technical solutions of the embodiments of the present application will be described in more detail below with reference to the accompanying drawings. It is obvious that the embodiments to be described are only some rather than all of the embodiments of the present application. All other embodiments obtained by those skilled in the art based on the embodiments of the present application without creative efforts shall fall within the scope of the present application.

It should be noted that if there are directional indications, such as up, down, left, right, front, back, etc., involved in the embodiments of the present application, the directional indications are only used to explain a certain posture as shown in the accompanying drawings. If the specific posture changes, the directional indication also changes accordingly.

In addition, if there are descriptions related to “first”, “second”, etc. in the embodiments of the present application, the descriptions of “first”, “second”, etc. are only for the purpose of description, and should not be construed as indicating or implying relative importance or implicitly indicates the number of technical features indicated. Thus, a feature delimited with “first”, “second” may expressly or implicitly include at least one of that feature. Besides, the meaning of “and/or” appearing in the application includes three parallel scenarios. For example, “A and/or B” includes only A, or only B, or both A and B. In addition, the technical solutions between the various embodiments can be combined with each other, but must be based on the realization by those skilled in the art. When the combination of technical solutions is contradictory or cannot be realized, it should be considered that the combination of such technical solutions does not exist or fall within the scope of protection claimed in the present application.

To solve the above problems, the present application provides a fixed-focus projection optical system 1000.

Firstly, it can be understood that the optical power is equal to the difference between the convergence of the image beam and the convergence of the object beam, which indicates the ability of the optical system to deflect light. The larger the absolute value of the optical power, the stronger the ability to bend light; and the smaller the absolute value of the optical power, the weaker the ability to bend light. When the optical power is a positive number, the refraction of light is convergent; when the optical power is a negative number, the refraction of light is divergent. The optical power can be used to indicate a certain refractive surface of a lens (i.e., a surface of the lens), can be used to indicate a certain lens, and can also be used to indicate a system formed by multiple lenses (i.e., a lens group).

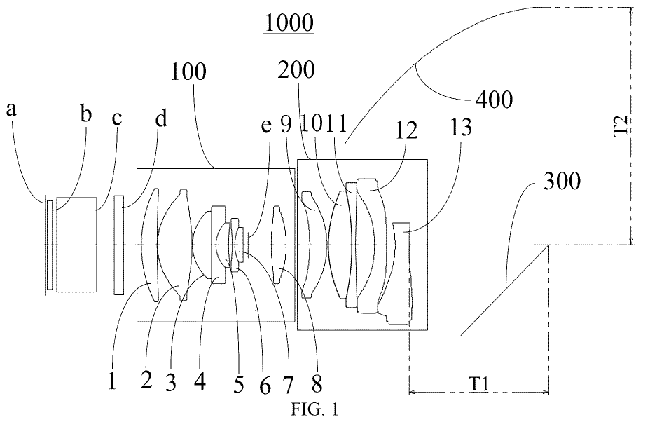

Referring to FIG. 1, in an embodiment of the present application, the fixed-focus projection optical system 1000 is provided with an object side and an image side opposite to each other along the optical axis direction. The fixed-focus projection optical system 1000 includes a micro-mirror array A, an equivalent prism C, a galvanometer D, a first lens group 100, a second lens group 200, a plane mirror 300, and a curved mirror 400 which are provided in sequence from the object side to the image side. The plane mirror 300 and the curved mirror 400 are respectively provided at both sides of the optical axis. The plane mirror 300 is provided at an angle with the optical axis, and one end of the plane mirror 300 is intersected with the optical axis. The optical power of the first lens group 100 is positive, the optical power of the second lens group 200 is positive, and the second lens group 200 can move along the optical axis to focus the fixed-focus projection optical system when the projection distance changes.

It should be noted that the micro-mirror array A is an optical element composed of a large number of micro-mirrors. By controlling the tilt angle of each micro-mirror, the incident light can be precisely controlled, thereby realizing the display of the image.

In addition, in an embodiment of the present application, the fixed-focus optical system further includes a protective glass B, which is provided between the equivalent prism C and the micro-mirror array A and is provided close to the micro-mirror array A, thereby providing effective protection for the micro-mirror array A.

In the technical solution of the present application, the image beam is emitted from the micro-mirror array A, and passes through the protective glass B, the equivalent prism C, the galvanometer D, the first lens group 100 and the second lens group 200 in sequence. When reaching the plane mirror 300, the beam is reflected by the plane mirror 300 to the curved mirror 400, and is reflected to the projection screen through the curved mirror 400, thereby changing the direction of the optical path and shortening the length of the projection direction. The first imaging is performed between the plane mirror 300 and the curved mirror 400, and the plane mirror 300 and the curved mirror 400 reflect the first imaging to the projection screen to form the second imaging. When it is necessary to change the size of the projected image or the projection ratio, the second lens group 200 moves along the optical axis toward the image side direction to focus the fixed-focus projection optical system 100. Through the reasonable arrangement of the structures and positions of the first lens group 100 with positive optical power, the second lens group 200 with negative positive optical power, and the plane mirror 300 and the curved mirror 400. The plane mirror 300 and the curved mirror 400 reflect the beam twice, which greatly reduces the length in the projection direction, so that the fixed-focus projection optical system 1000 has a small volume.

In an embodiment of the present application, the first lens group 100 includes a first lens 1, a second lens 2, a third lens 3, a fourth lens 4, a fifth lens 5, a sixth lens 6, a seventh lens 7, an aperture stop E, and an eighth lens 8, which are provided in sequence from the object side to the image side. The optical power of the first lens 1 is positive, and the optical power of the second lens 2 is positive. The optical power of the third lens 3 is positive, and the optical power of the fourth lens 4 is negative. The optical power of the fifth lens 5 is positive, and the optical power of the sixth lens 6 is negative. The optical power of the seventh lens 7 is positive, and the optical power of the eighth lens 8 is positive. The optical power of the first lens 1 is positive, and the object side of the first lens 1 is a convex surface, which helps to increase the main light angle of the edge field of view, and effectively increases the range of the field of view. The aperture stop E is provided between the seventh lens 7 and the eighth lens 8, so that the aperture stop E is located in the middle position of the system, so as to adjust the light flux according to actual conditions, reduce distortion, and improve the imaging quality. By comprehensively setting the optical power of each lens, the fixed-focus projection optical system 1000 can well control the light trend, introduce more light and make the structure more compact, and can achieve miniaturization. By combining different lenses and reasonably allocating optical power, it has a wide viewing angle, a short focal length, a low distortion, and a better imaging effect.

In addition, in an embodiment of the present application, the second lens group 200 includes a ninth lens 9, a tenth lens 10, an eleventh lens 11, a twelfth lens 12 and a thirteenth lens 13 provided in sequence from the object side to the image side. The optical power of the ninth lens 9 is positive, and the optical power of the tenth lens 10 is positive. The optical power of the eleventh lens 11 is negative, the optical power of the twelfth lens 12 is negative, and the optical power of the thirteenth lens 13 is negative. By comprehensively setting the optical power of each lens, the fixed-focus projection optical system 1000 can control the light trend well, make the structure more compact while introducing more light, and achieve miniaturization. By combining different lenses and reasonably allocating optical power, it has a large viewing angle, a short focal length, a low distortion, and a better imaging effect.

In an embodiment of the present application, the optical power of the first lens group 100 is φ100, the optical power of the second lens group 200 is φ200, and the optical power of the curved mirror is φ400. The optical power satisfies: 0.04≤|φ100|≤0.06, 0.003≤|φ200|≤0.01, and 0.04≤|φ400|≤0.08. According to the above optical power distribution, a projection ratio of less than 0.25 can be achieved. It can be understood that the projection ratio refers to the ratio between the projection distance of the projector and the width of the projection screen. The smaller the projection ratio, the larger the width of the projection screen at the same projection distance. On the contrary, the larger the ratio, the smaller the width of the projection screen. When projecting the same size of the screen, the projection ratio data is smaller, and the projection distance is closer, so that the lens with a smaller numerical projection ratio is easier to meet the space requirements of different scenes.

In order to improve the clarity at different projection distances, in an embodiment of the present application, the optical power of the first lens group 100 is φ100, the optical power of the second lens group 200 is φ200, and the ratio of the optical power of the first lens group 100 to the optical power of the second lens group 200 satisfies: 7≤/φ100/200|≤11. In this way, when the projection distance is changed, the second lens group 200 moves forward and backward to achieve zooming, which can improve the clarity at different projection distances and reduce distortion.

In an embodiment of the present application, the optical power of the first lens 1 is φ1, and the optical power of the second lens 2 is φ2. The sum of the optical powers of the third lens 3, the fourth lens 4, and the fifth lens 5 is φ345, and the sum of the optical powers of the sixth lens 6 and the seventh lens 7 is φ67. The optical power of the eighth lens 8 is φ8, and the optical power of the ninth lens 9 is φ9. The sum of the optical powers of the tenth lens 10 and the eleventh lens 11 is φ1011. The optical power of the twelfth lens 12 is φ12, the optical power of the thirteenth lens 13 is φ13, and the optical powers of the lenses satisfies: 0.01≤|φ1|≤0.03, 0.04≤|φ2|≤0.07, 0.002≤|φ345|≤0.05, 0.01≤|φ67|≤0.04, 0.02≤|φ8|≤0.05, 0.01≤|φ9|≤0.04, 0.01≤|φ1011|≤0.04, 0.01≤|φ12|≤0.04, 0.02≤|φ13|≤0.06. By limiting the optical power of each lens, the clarity of the fixed-focus projection optical system 1000 is improved.

In an embodiment of the present application, the first lens group 100 includes the first lens 1, the second lens 2, the third lens 3, the fourth lens 4, the fifth lens 5, the sixth lens 6, the seventh lens 7, the aperture stop E, and the eighth lens 8, which are provided in sequence from the object side to the image side. The second lens group 200 includes the ninth lens 9, the tenth lens 10, the eleventh lens 11, the twelfth lens 12, and the thirteenth lens 13, which are provided in sequence from the object side to the image side. The distance between the center of the thirteenth lens 13 and the center of the plane mirror 300 is T1, the distance between the center of the plane mirror 300 and the center of the curved mirror is T2, and the distance between the center of the first lens 1 and the center of the thirteenth lens 13 is T13, which satisfy: 0.5≤T13/(T1+T2)≤0.9. In this way, the reflected light can be incident on the curved mirror while the optical path of the curved mirror does not interfere with the first lens group 100 and the second lens group 200, which increases the projection effect.

In an embodiment of the present application, the first lens group 100 includes the first lens 1, the second lens 2, the third lens 3, the fourth lens 4, the fifth lens 5, the sixth lens 6, the seventh lens 7, the aperture stop E, and the eighth lens 8 provided in sequence from the object side to the image side. The distance from the first lens 1 to the intersection of the plane mirror 300 and the optical axis along the optical axis direction is T00, the distance from the micro-mirror array A to the first lens 1 is T11, and the ratio of T00 to T11 satisfies: T00/T11≤4.5. In this way, the volume is further reduced.

In an embodiment of the present application, the first lens group 100 includes the first lens 1, the second lens 2, the third lens 3, the fourth lens 4, the fifth lens 5, the sixth lens 6, the seventh lens 7, the aperture stop E, and the eighth lens 8 provided in sequence from the object side to the image side. The second lens group 200 includes the ninth lens 9, the tenth lens 10, the eleventh lens 11, the twelfth lens 12, and the thirteenth lens 13 provided in sequence from the object side to the image side.

The second lens 2, the eighth lens 8, and the ninth lens 9 are glass aspherical lenses, and the twelfth lens 12, the thirteenth lens 13, and the curved mirror 400 are plastic aspherical lenses.

It can be understood that the characteristics of the aspherical lenses are: the curvature changes continuously from the center of the lens to the periphery of the lens. Unlike spherical lenses with constant curvature from the center of the lens to the periphery of the lens, aspherical lenses have better curvature radius characteristics, and have the advantages of improving distortion aberration and improving astigmatism aberration. After using the aspherical lenses, the aberrations that occur during imaging can be eliminated as much as possible, thereby improving the imaging quality of the lens.

The second lens 2 is a glass aspherical surface, which can correct the coma and distortion caused by a large field of view. The eighth lens 8 is an aspherical surface, and the ninth lens 9 is an aspherical surface. At the same time, the twelfth lens 12, the thirteenth lens 13 and the curved mirror 400 are plastic aspherical surfaces. The aspherical surface further reduces the field curvature and distortion under different projection distances, thereby achieving a projection range of 40 to 150 feet.

In addition, the present application achieves no blurring and a high manufacturing yield when the brightness output is below 2000 lm through the reasonable combination of plastic lenses with positive and negative optical power.

In an embodiment of the present application, the surface shape of the aspheric lens in the fixed-focus projection optical system 1000 should satisfy the following equation:

Z=cy²/{1+\sqrt{1−(1+k)c²y²}}+Ay⁴+By⁶+Cy⁸+Dy¹⁰+Ey¹²+Fy¹⁴+Gy¹⁶ . . .

Where, c is the curvature corresponding to the radius; y is the radial coordinate (its unit is the same as the lens length unit); k is the conic quadratic coefficient, and A, B, C, D, E, F, G . . . represent the fourth-order, sixth-order, eighth-order, tenth-order, twelfth-order, fourteenth-order, sixteenth-order . . . aspheric coefficients respectively.

In an embodiment of the present application, the even-order coefficients of each aspheric surface are shown in Table 1 below.

TABLE 1

| surface number | k | A | B | C | D | E | F | G |
|---|---|---|---|---|---|---|---|---|
| second lens | −0.25806 | 2.96E−05 | −4.9E−08 | 2.02E−09 | 9.89E−12 | −3.9E−13 | 3.03E−15 | −6.9E−18 |
| object side | | | | | | | | |
| surface | | | | | | | | |
| second lens | −2.46267 | −7.7E−05 | 2.52E−07 | 1.06E−08 | −2.9E−10 | 3.45E−12 | −2E−14 | 4.88E−17 |
| image side | | | | | | | | |
| surface | | | | | | | | |
| eighth lens | −3.78378 | 3.16E−05 | 9.66E−07 | −4.6E−08 | 1.26E−09 | −2E−11 | 2.18E−13 | −1.1E−15 |
| object side | | | | | | | | |
| surface | | | | | | | | |
| eighth lens | 0.383548 | 4.88E−05 | −2.4E−07 | 2.25E−08 | −7.2E−10 | 1.32E−11 | −1.3E−13 | 8.21E−16 |
| image side | | | | | | | | |
| surface | | | | | | | | |
| ninth lens | 3.484826 | 0.00011 | −1.8E−06 | 2.78E−08 | −3.9E−10 | 4.54E−12 | −2.8E−14 | 6.23E−17 |
| object side | | | | | | | | |
| surface | | | | | | | | |
| ninth lens | 0.078976 | 5.77E−05 | −9.1E−07 | 1.25E−08 | −2.4E−10 | 3.24E−12 | −2.1E−14 | 4.79E−17 |
| image side | | | | | | | | |
| surface | | | | | | | | |
| twelfth lens | 1.105299 | 2.19E−05 | 7.84E−07 | −2.2E−08 | 2.67E−10 | −1.2E−12 | −3.9E−15 | 2.94E−17 |
| object side | | | | | | | | |
| surface | | | | | | | | |
| twelfth lens | 110.8142 | 6.75E−05 | 6.73E−07 | −1.9E−08 | 2.47E−10 | −1.8E−12 | 5.96E−15 | −8.4E−18 |
| image side | | | | | | | | |
| surface | | | | | | | | |
| thirteenth lens | −5.10484 | 9.71E−05 | −8.7E−07 | −4.1E−09 | 1.43E−10 | −1.1E−12 | 3.76E−15 | −4.1E−18 |
| object side | | | | | | | | |
| surface | | | | | | | | |
| thirteenth lens | 1.884723 | 0.000137 | −9.4E−07 | 4.41E−09 | −8.2E−12 | −2E−14 | 1.52E−16 | −2.3E−19 |
| image side | | | | | | | | |
| surface | | | | | | | | |
| curved mirror | −2.3221 | −3.4E−06 | 1.14E−09 | −5.1E−13 | 1.86E−16 | −9.5E−20 | 3.4E−23 | −5.1E−27 |

Further, in an embodiment of the present application, the third lens 3, the fourth lens 4 and the fifth lens 5 are glued together, the sixth lens 6 and the seventh lens 7 are glued together, and the tenth lens 10 and the eleventh lens 11 are glued together. By gluing the third lens 3, the fourth lens 4 and the fifth lens 5, the chromatic aberration of the large field of view is corrected. The sixth lens 6 and the seventh lens 7 are double-glued lenses, which further correct the magnification chromatic aberration of the correction system, so that the system obtains a smaller chromatic aberration and can increase the light height of the off-axis field of view, so that the system has a larger target surface.

In addition, in an embodiment of the present application, the first lens 1, the third lens 3, the fourth lens 4, the fifth lens 5, the sixth lens 6, the seventh lens 7, the tenth lens 10, and the eleventh lens 11 are glass spherical lenses. In order to improve the imaging quality of the lens at various magnifications, the present application combines high refractive index glass with ultra-low dispersion glass materials to reduce various optical aberrations while effectively suppressing the chromatic aberration of the system. At the same time, since the glass lens is not easily affected by thermal expansion and contraction and has a focus shift phenomenon, the glass lens can well resist the problem of lens deformation due to heat and maintain the high precision of the lens for a long time. In addition, the aberrations that occur during imaging can be eliminated as much as possible, thereby improving the imaging quality of the lens and reducing the influence of temperature on the optical performance of the lens.

In an embodiment of the present application, when the projection ratio is 0.25, the micro-mirror array A is 0.47 inches, and the chip pixel size is 5.4 microns. T00/T11≤4.5, and the parameters of the zoom lens are shown in Table 2 below.

TABLE 2

| surface number | type | radius R | thickness | optical material | aperture |
|---|---|---|---|---|---|
| OBJ | object surface | infinity | 0 | | 17.8 |
| micro-mirror array | standard | infinity | 0.323123 | | 17.8 |
| protective glass object | standard | infinity | 1.1 | HK9L_CDGM | 21.6 |
| side surface | | | | | |
| protective glass image | standard | infinity | 1 | | 18.0 |
| side surface | | | | | |
| equivalent prism object | standard | infinity | 8.37 | HK9L_CDGM | 19.8 |
| side surface | | | | | |
| equivalent prism image | standard | infinity | 3.7 | | 18.4 |
| side surface | | | | | |
| galvanometer object | standard | infinity | 2 | B270_SCHOTT | 0.0 |
| side surface | | | | | |
| galvanometer image | standard | −25.162 | 3.64 | | 19.9 |
| side surface | | | | | |
| first lens object side | standard | −159.140 | 3.32 | FC5_HOYA | 22.7 |
| surface | | | | | |
| first lens image side | standard | −12.366 | 0.09 | | 21.9 |
| surface | | | | | |
| second lens object side | aspheric | 31.147 | 7.30 | MFCD1_HOYA | 17.2 |
| surface | surface | | | | |
| second lens image side | aspheric | −9.167 | 0.10 | | 15.5 |
| surface | surface | | | | |
| third lens object side | standard | 229.071 | 4.15 | FC5_HOYA | 14.8 |
| surface | | | | | |
| third lens image side | standard | −6.150 | 0.75 | TAFD55_HOYA | 13.4 |
| surface and fourth lens | | | | | |
| object side surface | | | | | |
| fourth lens image side | standard | −26.404 | 2.63 | HK9L_CDGM | 10.9 |
| surface and fifth lens | | | | | |
| object side surface | | | | | |
| fifth lens image side | standard | 26.366 | 0.81 | | 10.3 |
| surface | | | | | |
| sixth lens object side | standard | −8.429 | 0.50 | TAFD25_HOYA | 10.2 |
| surface | | | | | |
| sixth lens image side | standard | 85.343 | 1.82 | HZF62_CDGM | 9.4 |
| surface and seventh | | | | | |
| lens object side surface | | | | | |
| seventh lens image side | standard | −37.884 | 4.86 | | 8.8 |
| surface | | | | | |
| STO | aperture stop | infinity | 1.07 | | 9.1 |
| eighth lens object side | aspheric | 21.727 | 3.10 | HQK3L_CDGM | 6.7 |
| surface | surface | | | | |
| eighth lens image side | aspheric | 37.716 | 4.95 | | 19.4 |
| surface | surface | | | | |
| ninth lens object side | aspheric | 18.027 | 3.60 | MFD80_HOYA | 19.6 |
| surface | surface | | | | |
| ninth lens image side | aspheric | −24.878 | 0.26 | | 19.7 |
| surface | surface | | | | |
| tenth lens object side | standard | 49.970 | 4.96 | HQF50A_CDGM | 22.2 |
| surface | | | | | |
| tenth lens image side | standard | −241.105 | 0.84 | HZF62_CDGM | 25.3 |
| surface glued with the | | | | | |
| eleventh lens object | | | | | |
| side surface | | | | | |
| eleventh lens image | standard | 20.315 | 4.00 | | 24.1 |
| side surface | | | | | |
| twelfth lens object side | aspheric | 136.436 | 2.50 | Z350R_ZEON | 23.8 |
| surface | surface | | | | |
| twelfth lens image side | aspheric | 19.546 | 1.80 | | 22.7 |
| surface | surface | | | | |
| thirteenth lens object | aspheric | −37.616 | 2.90 | Z350R_ZEON | 22.8 |
| side surface | surface | | | | |
| thirteenth lens image | aspheric | infinity | 29.43 | | 24.4 |
| side surface | surface | | | | |
| plane mirror object side | standard | infinity | — | Mirror | — |
| surface | | | | | |
| plane mirror image side | standard | infinity | 48.81 | | — |
| surface | | | | | |
| curved mirror | aspheric | −32.64 | — | Mirror | 84.2 |
| | surface | | | | |
| IMA | standard | infinity | 380 | | 2440 |

In addition, under different projection sizes, the moving distance of the second lens group is as follows:

projection size

| surface number | 68 feet | 40 feet | 150 feet |
|---|---|---|---|
| eighth lens image side | 4.95 | 5.652 | 4.32 |
| surface | | | |
| thirteenth lens image side | 29.43 | 28.728 | 30.06 |
| surface | | | |

In addition, in order to better change the direction of the optical path, in an embodiment of the present application, the angle between the plane mirror 300 and the optical axis of the refractor group is 45°, which changes the direction of the optical path, greatly shortens the length of the system along the projection direction, and further improves the miniaturization of the fixed-focus projection optical system 1000.

The above are only embodiments of the present application, and do not limit the scope of the present application. Under the technical concept of the present application, all equivalent structural changes made by using the contents of the specification and drawings of the present application, or directly/indirectly applied in other related technical fields are included in the scope of the present application.

What is claimed is:

1. A fixed-focus projection optical system, provided with an object side and an image side arranged relatively along an optical axis direction, comprising a micro-mirror array, an equivalent prism, a galvanometer, a first lens group, a second lens group, a plane mirror, and a curved mirror provided in sequence from the object side to the image side, wherein:
the plane mirror is provided at one side of the optical axis, and the curved mirror is provided at the other side of the optical axis;
the plane mirror is provided at an angle with the optical axis, and one end of the plane mirror is intersected with the optical axis;
an optical power of the first lens group is positive, and an optical power of the second lens group is negative; and
the second lens group is configured to move along the optical axis to focus the fixed-focus projection optical system in response to that a projection distance is changed.

2. The fixed-focus projection optical system according to claim 1, wherein the first lens group comprises a first lens, a second lens, a third lens, a fourth lens, a fifth lens, a sixth lens, a seventh lens, an aperture stop, and an eighth lens provided in sequence from the object side to the image side;
an optical power of the first lens is positive, and an optical power of the second lens is positive; an optical power of the third lens is positive, and an optical power of the fourth lens is negative; an optical power of the fifth lens is positive, and an optical power of the sixth lens is negative; an optical power of the seventh lens is positive, and an optical power of the eighth lens is positive; and
the second lens group comprises a ninth lens, a tenth lens, an eleventh lens, a twelfth lens, and a thirteenth lens provided in sequence from the object side to the image side; an optical power of the ninth lens is positive, and an optical power of the tenth lens is positive; an optical power of the eleventh lens is negative, and an optical power of the twelfth lens is negative; and an optical power of the thirteenth lens is negative.

3. The fixed-focus projection optical system according to claim 1, wherein the optical power of the first lens group is φ100, and the optical power of the second lens group is φ200; and
the optical power of the curved mirror is φ400, and the optical powers satisfy:
0.04≤|φ100|≤0.06, 0.003≤|φ200|≤0.01, and 0.04≤|φ400|≤0.08.

4. The fixed-focus projection optical system according to claim 1, wherein the optical power of the first lens group is 100, and the optical power of the second lens group is φ200; and
a ratio of the optical power of the first lens group to the optical power of the second lens group satisfies:
7≤/φ100/φ200|≤11.

5. The fixed-focus projection optical system according to claim 2, wherein the optical power of the first lens is φ1, and the optical power of the second lens is φ2; a sum of the optical power of the third lens, the optical power of the fourth lens, and the optical power of the fifth lens is φ345; a sum of the optical power of the sixth lens and the optical power of the seventh lens is φ67, and an optical power of the eighth lens is 8; an optical power of the ninth lens is φ9, and a sum of the optical power of the tenth lens and the optical power of the eleventh lens is φ1011; the optical power of the twelfth lens is φ12, and the optical power of the thirteenth lens is φ13; and
the optical powers of the lenses satisfy:
0.01≤|φ1|≤0.03, 0.04≤|2|≤0.07, 0.002≤|φ345|≤0.05, 0.01≤|φ67|≤0.04, 0.02≤|φ8|≤0.05, 0.01≤|φ9|≤0.04, 0.01≤|φ1011|≤0.04, 0.01≤|φ12|≤0.04, and 0.025|φ13|≤0.06.

6. The fixed-focus projection optical system according to claim 1, wherein the first lens group comprises a first lens, a second lens, a third lens, a fourth lens, a fifth lens, a sixth lens, a seventh lens, an aperture stop, and an eighth lens provided in sequence from the object side to the image side, and the second lens group comprises a ninth lens, a tenth lens, an eleventh lens, a twelfth lens, and a thirteenth lens provided in sequence from the object side to the image side; and
a distance between a center of the thirteenth lens and a center of the plane mirror is T1, and a distance between a center of the plane mirror and a center of the curved mirror is T2; and a distance between a center of the first lens and the center of the thirteenth lens is T13, satisfying:
0.5≤T13/(T1+T2)≤0.9.

7. The fixed-focus projection optical system according to claim 1, wherein the first lens group comprises a first lens, a second lens, a third lens, a fourth lens, a fifth lens, a sixth lens, a seventh lens, an aperture stop, and an eighth lens provided in sequence from the object side to the image side; and
a distance from the first lens to an intersection of the plane mirror and the optical axis along the optical axis direction is T00, and a distance from the micro-mirror array to the first lens is T11; and a ratio of T00 to T11 satisfies:
T00/T11≤4.5.

8. The fixed-focus projection optical system according to claim 1, wherein the first lens group comprises a first lens, a second lens, a third lens, a fourth lens, a fifth lens, a sixth lens, a seventh lens, an aperture stop, and an eighth lens provided in sequence from the object side to the image side;
the second lens group comprises a ninth lens, a tenth lens, an eleventh lens, a twelfth lens, and a thirteenth lens provided in sequence from the object side to the image side; and
the second lens, the eighth lens, and the ninth lens are glass aspherical lenses, and the twelfth lens, the thirteenth lens, and the curved mirror are plastic aspherical lenses.

9. The fixed-focus projection optical system according to claim 1, wherein the first lens group comprises a first lens, a second lens, a third lens, a fourth lens, a fifth lens, a sixth lens, a seventh lens, an aperture stop, and an eighth lens provided in sequence from the object side to the image side, and the second lens group comprises a ninth lens, a tenth lens, an eleventh lens, a twelfth lens, and a thirteenth lens provided in sequence from the object side to the image side; and
the third lens, the fourth lens, and the fifth lens are glued together; the sixth lens is glued to the seventh lens, and the tenth lens is glued to the eleventh lens.

10. The fixed-focus projection optical system according to claim 1, wherein an angle between the plane mirror and an optical axis of a refractive lens group is 45°.
